(19) United States
(12) Patent Application Publication
(10) Pub. No.: US 2025/0085984 A1
(43) Pub. Date: Mar. 13, 2025

(54) DATA PROCESSING METHOD AND APPARATUS, AND ELECTRONIC DEVICE AND READABLE MEDIUM

(71) Applicant: NETEASE (HANGZHOU) NETWORK CO., LTD., Hangzhou, Zhejiang (CN)

(72) Inventor: Jian WANG, Hangzhou, Zhejiang (CN)

(73) Assignee: NETEASE (HANGZHOU) NETWORK CO., LTD., Hangzhou, Zhejiang (CN)

(21) Appl. No.: 18/726,840

(22) PCT Filed: Jun. 20, 2022
(86) PCT No.: PCT/CN2022/099812

§ 371 Date: Jul. 5, 2024

(30) Foreign Application Priority Data
Jan. 29, 2022 (CN) 202210111723.3

(51) Int. Cl. G06F 9/451; G06F 3/04883

(52) U.S. Cl. CPC G06F 9/451; G06F 3/04883

(57) ABSTRACT

A data processing method includes obtaining, in response to a touch control operation on a virtual model, a first grid position of the touch control operation in a model grid of the virtual model at a (n+1)-th timepoint, where n≥1; determining, based on the first grid position, a first texture position of a texture map of the virtual model; obtaining information, in a render texture corresponding to the touch control operation at an n-th timepoint, of a color of a historical touch control region of the touch control operation; obtaining, a target color of the first texture position by mixing the color of the historical touch control region with a color of the first texture position; updating the color of the first texture position of the texture map as the target color; and rendering, based on the texture map as updated, the virtual model at the (n+1)-th timepoint.

### CROSS-REFERENCE TO RELATED APPLICATIONS

The present disclosure claims the priority to the Chinese Patent Application No. 202210111723.3, entitled “DATA PROCESSING METHOD AND APPARATUS, AND ELECTRONIC DEVICE AND READABLE MEDIUM”, submitted on Jan. 29, 2022, and the entire contents of which are incorporated into the present disclosure by reference.

### TECHNICAL FIELD

The present disclosure relates to the field of computer technology, and in particular to a data processing method, a data processing apparatus, an electronic device, and a computer-readable medium.

### BACKGROUND

In general, when a virtual model needs to be colored, a brush can usually be used to color the virtual model. However, the brush that can be used for the virtual model usually can only fill a single color in an area where the brush is applied, but cannot show a color gradient effect through a single application of the brush. For example, in the case of applying eye shadow to a face of a three-dimensional model of human body, existing brushes are unable to show the gradual effect of the eye shadow color from thick to light in the process of the single application of the eye shadow.

### SUMMARY

Embodiments of the present disclosure propose a data processing method and apparatus, an electronic device and a computer-readable storage medium that overcome the above problem or at least partially solve the above problem.

The embodiments of the present disclosure disclose a data processing method, including:
obtaining, in response to a touch control operation on a virtual model, a current grid position of the touch control operation in a model grid of the virtual model at a current (n+1)-th timepoint, where n≥1;
determining, based on the current grid position, a current texture position of a texture map of the virtual model;
collecting a render texture corresponding to the touch control operation at an n-th timepoint, and obtaining information, in the render texture, of a color of a historical touch control region of the touch control operation, where the render texture is a texture generated based on a color of a historical position of the touch control operation in the texture map;
obtaining a target color of the current texture position by mixing the color of the historical touch control region with a current color of the current texture position;
updating the color of the current texture position of the texture map as the target color; and
rendering, based on the texture map as updated, the virtual model at the (n+1)- th timepoint.

Optionally, the step of determining, based on the current grid position, the current texture position of the texture map of the virtual model includes:
determining whether an overlap is present between a preset region mask and the current grid position;
if the overlap is present between the preset region mask and the current grid position, determining a region in the current grid position outside the overlap between the current grid position and the region mask as a target grid position; and
determining, based on the target grid position, the current texture position of the texture map of the virtual model.

Optionally, the step of collecting the render texture corresponding to the touch control operation at the n-th timepoint includes:
obtaining the render texture corresponding to the n-th timepoint by capturing, based on a virtual camera, the historical touch control region corresponding to the touch control operation at the n-th timepoint.

Optionally, the step of collecting the render texture corresponding to the touch control operation at the n-th timepoint includes:
determining whether an overlap is present between a preset region mask and the historical touch control region corresponding to the touch control operation at the n-th timepoint; and
if the overlap is present between the preset region mask and the historical touch control region corresponding to the touch control operation at the n-th timepoint, obtaining the render texture by collecting a region in the historical touch control region outside the overlap between the historical touch control region and the region mask.

Optionally, the method further includes:
for a first timepoint, obtaining, in response to the touch control operation on the virtual model, a current grid position of the touch control operation in the model grid of the virtual model at the first timepoint;
determining, based on the current grid position, a current texture position of the texture map of the virtual model;
updating a color of the current texture position of the texture map as a preset initial color; and
rendering, based on the texture map as updated, the virtual model at the first timepoint.

Optionally, the step of obtaining the target color of the current texture position by mixing the color of the historical touch control region with the current color of the current texture position includes:
determining a first mixing proportion corresponding to the historical touch control region, and a second mixing proportion corresponding to the current texture position; and
obtaining the target color of the current texture position by mixing, based on the first mixing proportion and the second mixing proportion, the color of the historical touch control region with the current color corresponding to the current texture position.

The embodiments of the present disclosure also provide a data processing apparatus, including:
a model position determining module, configured to obtain, in response to a touch control operation on a virtual model, a current grid position of the touch control operation in a model grid of the virtual model at a current (n+1)-th timepoint, where n≥1;
a texture position determining module, configured to determine, based on the current grid position, a current texture position of a texture map of the virtual model;
a render texture collecting module, configured to collect a render texture corresponding to the touch control operation at an n-th timepoint, and obtain information, in the render texture, of a color of a historical touch control region of the touch control operation, where the render texture is a texture generated based on a color of a historical position of the touch control operation in the texture map;
a mixing module, configured to obtain a target color of the current texture position by mixing the color of the historical touch control region with a current color of the current texture position;
a color updating module, configured to update the color of the current texture position of the texture map as the target color; and
a model updating module, configured to render, based on the texture map as updated, the virtual model at the (n+1)-th timepoint.

Optionally, the texture position determining module includes:
a first overlap determining sub-module, configured to determine whether an overlap is present between a preset region mask and the current grid position;
a target grid position determining sub-module, configured to, if the overlap is present between the preset region mask and the current grid position, determine a region in the current grid position outside the overlap between the current grid position and the region mask as a target grid position; and
a texture position determining sub-module, configured to determine, based on the target grid position, the current texture position of the texture map of the virtual model.

Optionally, the render texture collecting module includes:
a first render texture collecting sub-module, configured to obtain the render texture corresponding to the n-th timepoint by capturing, based on a virtual camera, the historical touch control region corresponding to the touch control operation at the n-th timepoint.

Optionally, the render texture collecting module includes:
a second overlap determining sub-module, configured to determine whether an overlap is present between a preset region mask and the historical touch control region corresponding to the touch control operation at the n-th timepoint; and
a second render texture collecting sub-module, configured to, if the overlap is present between the preset region mask and the historical touch control region corresponding to the touch control operation at the n-th timepoint, obtain the render texture by collecting a region in the historical touch control region outside the overlap between the historical touch control region and the region mask.

Optionally, the apparatus further includes:
a first timepoint model position determining module, configured to, for a first timepoint, obtain, in response to the touch control operation on the virtual model, a current grid position of the touch control operation in the model grid of the virtual model at the first timepoint;
a first timepoint texture position determining module, configured to determine, based on the current grid position, a current texture position of the texture map of the virtual model;
an initial color updating module, configured to update a color of the current texture position of the texture map as a preset initial color;
a first timepoint rendering module, configured to render, based on the texture map as updated, the virtual model at the first timepoint.

Optionally, the mixing module includes:
a proportion determining sub-module, configured to determine a first mixing proportion corresponding to the historical touch control region, and a second mixing proportion corresponding to the current texture position; and
a mixing sub-module, configured to obtain the target color of the current texture position by mixing, based on the first mixing proportion and the second mixing proportion, the color of the historical touch control region with the current color corresponding to the current texture position.

The embodiments of the present disclosure also provide an electronic device, including a processor, a communication interface, a memory, and a communication bus, where the processor, the communication interface, and the memory communicate with each other via the communication bus;
the memory is configured to store a computer program; and
the processor, when executing the program stored in the memory, is configured to implement the method as described in the embodiments of the present disclosure.

The embodiments of the present disclosure also provide one or more computer-readable media, storing an instruction that, when executed by one or more processors, causes the processor to perform the method as described in the embodiments of the present disclosure.

The embodiments of the present invention include the following advantages.

Through the data processing method in the present disclosure, the current grid position of the touch control operation in the model grid of the virtual model at the current (n+1)-th timepoint is obtained in response to the touch control operation on the virtual model, where n≥1; the current texture position of the texture map of the virtual model is determined based on the current grid position; the render texture corresponding to the touch control operation at the n-th timepoint is collected, and the information, in the render texture, of the color of the historical touch control region of the touch control operation is obtained, where the render texture is the texture generated based on the color of the historical position of the touch control operation in the texture map; the target color of the current texture position is obtained by mixing the color of the historical touch control region with the current color of the current texture position; the color of the current texture position of the texture map is updated as the target color; and the virtual model at the (n+1)-th timepoint is rendered based on the texture map as updated, so as to achieve the effect of coloring and applying the virtual model with the gradient color in the three-dimensional space.

### BRIEF DESCRIPTION OF THE DRAWINGS

FIG. 1 is a flowchart of steps of a data processing method provided in an embodiment of the present disclosure.

FIG. 2 is a flowchart of steps of a data processing method provided in an embodiment of the present disclosure.

FIG. 3 is a schematic diagram of a region mask provided in an embodiment of the present disclosure.

FIG. 4 is a schematic diagram of a virtual model rendering provided in an embodiment of the present disclosure.

FIG. 5 is a block diagram of a structure of a data processing apparatus provided in an embodiment of the present disclosure.

FIG. 6 is a block diagram of an electronic device provided in an embodiment of the present disclosure.

FIG. 7 is a schematic diagram of a computer-readable medium provided in an embodiment of the present disclosure.

### DETAILED DESCRIPTION

In order to make the above objects, features and advantages of the present disclosure more apparent and understandable, the present disclosure is described in further detail below in conjunction with the accompanying drawings and specific embodiments.

In the embodiments of the present disclosure, in cases where make-up is required to be applied to a virtual model of human body, an ink style texture is required to be added to the virtual model, etc., the user may expect a color gradient effect to be displayed in real time during the coloring process.

If the coloring on the virtual model is performed after a single operation is completed, the start point and the end point of the single operation are determined at this time, then the start point color and the end point color of the single operation can be determined respectively, and then the color of the middle portion of the single operation can be determined based on the start point color and the end point color, so as to form the color gradient effect.

However, the user often also expects that the coloring effect can be observed in real time during the coloring process. Accordingly, the embodiments of the present disclosure identify in real time the region at which the touch control operation is performed at each timepoint, and obtain the target color of the current texture position by mixing the color of the historical touch control region at which the touch control operation is performed with the current color of the current texture position, so that real-time coloring on the virtual model can be achieved through the virtual operation.

In addition, since the virtual model is typically uneven, continuous position changes on the virtual model may involve position changes in multiple directions in the three-dimensional space, and thus when mapped to the texture map corresponding to the virtual model, discontinuous position changes in the texture map may occur. In the process of coloring the virtual model, in the face of the discontinuous texture map, it is not possible to simply determine the offset of the movement of the virtual operation at each timepoint, and thus it is not possible to determine, based on the offset, the region at which the virtual operation is located at the previous timepoint, and to extract and obtain the color of the region. Accordingly, the embodiments of the present disclosure obtain the render texture that records the color of the region by pre-collecting the color of the texture map of the region at which the virtual operation is located at the previous timepoint, and then the color corresponding to the region at which the virtual operation is located at the previous timepoint may be easily determined based on the render texture, so that the color mixing can be easily accomplished.

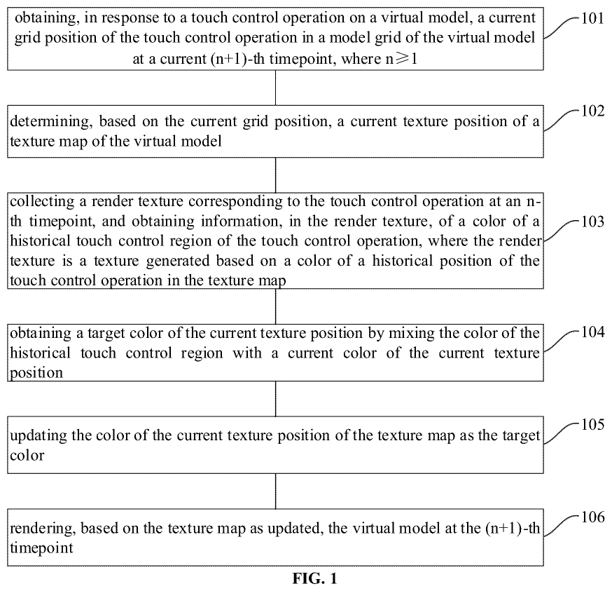

Referring to FIG. 1, a flowchart of steps of a data processing method provided in an embodiment of the present disclosure is shown, which may specifically include the following steps 101 to 106.

At step 101, a current grid position of a touch control operation in a model grid of a virtual model at a current (n+1)-th timepoint is obtained in response to the touch control operation on the virtual model, where n≥1.

In an embodiment of the present disclosure, the virtual model may be a three-dimensional model. For example, a three-dimensional model of human body, an animal model, a plant model, an architectural model, etc.

If the user needs to color the virtual model, the touch control operation may be performed on the virtual model. Each touch control operation may be a continuous, uninterrupted movement, i.e., each touch control operation may be considered as a single brush drawing, which may draw a continuous pattern.

During a period of time when the user performs the touch control operation, the position where the coloring needs to be performed currently may be determined by obtaining in real time the current grid position of the touch control operation in the model grid of the virtual model at the current (n+1)-th timepoint.

In some embodiments, the touch control operation may add a preset color on the virtual model at the first timepoint, thereafter from the second timepoint onwards, as the touch control operation moves, the added color is mixed with the color that the texture of the virtual model has, thereby achieving the effect of coloring and applying. So n≥1.

Specifically, the virtual model may be displayed through a display screen in an electronic device. The user may issue the touch control operation by touching the display screen or using a peripheral device connected to the electronic device, for example, a mouse, a stylus, a keyboard, etc. The touch control operation, by directing to a certain position in the display screen, may direct to a certain position in the virtual model displayed on the display screen, so that the current grid position of the touch control operation in the model grid of the virtual model can be determined.

In a specific implementation, the touch control operation of the user may be used for controlling a brush mask, and the position currently covered by the brush mask may be considered as the current grid position at which the touch control operation is located in the model grid of the virtual model.

At step 102, a current texture position of a texture map of the virtual model is determined based on the current grid position.

After the current grid position at which the touch control operation is currently located is determined, the current texture position, corresponding to the current grid position, of the texture map of the virtual model may be further determined based on the current grid position, thereby determining the position in the texture map where coloring needs to be performed.

In a specific implementation, a correspondence relationship between the grid position of the model grid in the three-dimensional space and the texture position of the texture map of the virtual model may be preset, so that after the current grid position of the model grid corresponding to the touch control operation is determined, the current texture position, corresponding to the current grid position, of the texture map of the virtual model may be determined based on the preset correspondence relationship.

At step 103, a render texture corresponding to the touch control operation at an n-th timepoint is collected, and information, in the render texture, of a color of a historical touch control region of the touch control operation is obtained, where the render texture is a texture generated based on a color of a historical position of the touch control operation in the texture map.

Specifically, in order to achieve the color gradient effect, the color of the historical touch control region at which the touch control operation is located at the n-th timepoint may be mixed with the current color of the current texture position, so that the target color determined at each timepoint is changed based on the color of the historical touch control region, and thus the effect of the gradual change of color can be displayed.

Accordingly, the render texture corresponding to the n-th timepoint in the touch control operation may be collected in advance, so that in the case where the position changes of the texture map corresponding to the touch control operation may be discontinuous, the recording of the target color at the previous timepoint of the current timepoint can be achieved by collecting in advance the texture generated based on the color of the historical position at which the touch control operation is located in the texture map, in order to handle the color mixing. Specifically, the render texture records a variety of information such as the size, dimension, color, etc. of the historical touch control region. Therefore, the information of the color of the historical touch control region of the touch control operation may be obtained from the render texture.

At step 104, a target color of the current texture position is obtained by mixing the color of the historical touch control region with the current color of the current texture position.

After the color of the historical touch control region is obtained through the render texture, from the texture map, the current texture position may be further determined, and the current color of the current texture position may be extracted. Subsequently, the target color of the current texture position may be determined by mixing the color of the historical touch control region with the current color of the current texture position.

At step 105, the color of the current texture position of the texture map is updated as the target color.

After the target color to be added to the current texture position is determined, the target color is used to update the color of the current texture position in the texture map, thereby completing the coloring of the texture corresponding to the current grid position in the virtual model.

The target color of the current texture position is determined based on the texture color corresponding to the historical touch control region at which the touch control operation is located at the previous timepoint, i.e., the n-th timepoint, and the texture color corresponding to the current touch control region, i.e., the (n+1)-th timepoint. As a result, the target color may be based on the color of the historical touch control region, and changed with reference to the current color of the current texture position. This allows for color gradient based on the color of the historical touch control region and better fusion with the current color of the virtual model, achieving a natural color gradient effect.

At step 106, the virtual model at the (n+1)-th timepoint is rendered based on the texture map as updated.

After the color of the current texture position of the texture map is updated, the virtual model at the (n+1)-th timepoint may be rendered by using the texture map as updated, so as to achieve the real-time display of the coloring effect of the virtual model during the process of coloring the virtual model through the touch control operation, and achieve the function of providing the user with real-time coloring and applying of the virtual model in the three-dimensional space.

Through the data processing method in the present disclosure, the current grid position of the touch control operation in the model grid of the virtual model at the current (n+1)-th timepoint is obtained in response to the touch control operation on the virtual model, where n≥1; the current texture position of the texture map of the virtual model is determined based on the current grid position; the render texture corresponding to the touch control operation at the n-th timepoint is collected, and the information, in the render texture, of the color of the historical touch control region of the touch control operation is obtained, where the render texture is the texture generated based on the color of the historical position of the touch control operation in the texture map; the target color of the current texture position is obtained by mixing the color of the historical touch control region with the current color of the current texture position; the color of the current texture position of the texture map is updated as the target color; and the virtual model at the (n+1)-th timepoint is rendered based on the texture map as updated, so as to achieve the effect of coloring and applying the virtual model with the gradient color in the three-dimensional space.

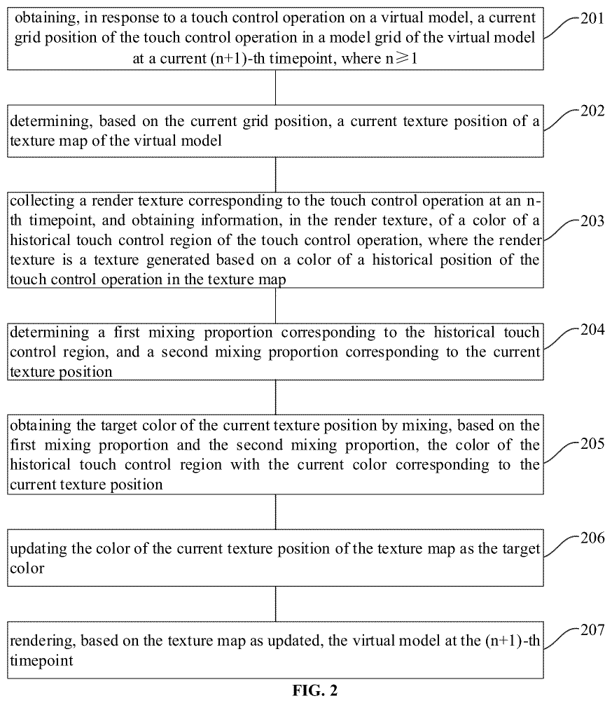

Referring to FIG. 2, a flowchart of steps of a data processing method provided in an embodiment of the present disclosure is shown, which may specifically include the following steps 201 to 207.

At step 201, a current grid position of a touch control operation in a model grid of a virtual model at a current (n+1)-th timepoint is obtained in response to the touch control operation on the virtual model, where n≥1.

If the user needs to color the virtual model, the touch control operation may be performed on the virtual model. Each touch control operation may be a continuous, uninterrupted movement, i.e., each touch control operation may be considered as a single brush drawing, which may draw a continuous pattern.

During a period of time when the user performs the touch control operation, the position where the coloring needs to be performed currently may be determined by obtaining in real time the current grid position of the touch control operation in the model grid of the virtual model at the current (n+1)-th timepoint.

In some embodiments, the touch control operation may add a preset color on the virtual model at the first timepoint, thereafter from the second timepoint onwards, as the touch control operation moves, the added color is mixed with the color that the texture of the virtual model has, thereby achieving the effect of coloring and applying. S on≥1.

Specifically, the virtual model may be displayed through a display screen in an electronic device. The user may issue the touch control operation by touching the display screen or using a peripheral device connected to the electronic device, for example, a mouse, a stylus, a keyboard, etc. The touch control operation, by directing to a certain position in the display screen, may direct to a certain position in the virtual model displayed on the display screen, so that the current grid position of the touch control operation in the model grid of the virtual model can be determined.

In a specific implementation, the touch control operation of the user may be used for controlling a brush mask, and the position currently covered by the brush mask may be considered as the current grid position at which the touch control operation is located in the model grid of the virtual model.

In an example of the present disclosure, the method further includes steps S11 to S14.

At S11, for a first timepoint, a current grid position of the touch control operation in the model grid of the virtual model at the first timepoint is obtained in response to the touch control operation on the virtual model.

In order to achieve the effect of coloring and applying of the model, at the first timepoint, the virtual model may be colored, and thereafter, as the touch control operation moves at subsequent timepoints, other positions of the virtual model are colored based on the color added at the first timepoint, thereby achieving the effect of naturally applying the added color to other regions.

Thus, for the first timepoint, the current grid position of the touch control operation in the model grid of the virtual model at the first timepoint may be obtained in response to the touch control operation on the virtual model, thereby determining the position of the virtual model where the coloring needs to be performed.

At S12, a current texture position of a texture map of the virtual model is determined based on the current grid position.

After the current grid position of the touch control operation in the model grid of the virtual model at the first timepoint is determined, in order to achieve coloring of the virtual model, the current texture position, in the texture map of the virtual model, corresponding to the current grid position may be further determined.

Specifically, a correspondence relationship between the grid position of the model grid in the three-dimensional space and the texture position of the texture map of the virtual model may be preset, so that after the current grid position of the model grid corresponding to the touch control operation is determined, the current texture position, corresponding to the current grid position, of the texture map of the virtual model may be determined based on the preset correspondence relationship.

At S13, a color of the current texture position of the texture map is updated as preset initial color.

After the current texture position of the texture map is determined, the color of the current texture position of the texture map may be updated as the preset initial color, thereby achieving the coloring of the virtual model. In some embodiments, the preset initial color may be determined by a user selection.

At S14, the virtual model at the first timepoint is rendered based on the texture map as updated.

After the updating of the texture map is completed, the virtual model at the first timepoint may be rendered based on the texture map as updated, so that the real-time color display effect may be shown to the user.

At step 202, a current texture position of a texture map of the virtual model is determined based on the current grid position.

After the current grid position at which the touch control operation is currently located is determined, the current texture position, corresponding to the current grid position, of the texture map of the virtual model may be further determined based on the current grid position, thereby determining the position in the texture map where coloring needs to be performed.

In a specific implementation, a correspondence relationship between the grid position of the model grid in the three-dimensional space and the texture position of the texture map of the virtual model may be preset, so that after the current grid position of the model grid corresponding to the touch control operation is determined, the current texture position, corresponding to the current grid position, of the texture map of the virtual model may be determined based on the preset correspondence relationship.

In an embodiment of the present disclosure, the step of determining, based on the current grid position, the current texture position of the texture map of the virtual model includes steps S21 to S23.

At S21, whether an overlap is present between a preset region mask and the current grid position is determined.

Specifically, the virtual model may not need to be colored at all positions, but only at part of the positions. For example, in the case of applying make-up to the face of the three-dimensional model of human body, if coloring is applied to the cheek, it may not be desired to apply the color to portions other than the cheek, such as the nose, lip, etc., and it may only be desired to apply the color to the cheek. At the same time, it is not desired that the colors of the positions at which other portions are located have an effect on the current coloring.

In this case, in order to avoid the undesirable effect of the irrelevant region on the current coloring and applying process, the preset region mask may be used to mask the irrelevant region. As a result, after the current grid position of the touch control operation in the model grid of the virtual model is determined, it is also required to further determine whether the overlap is present between the current grid position and the region mask, thereby determining whether the current grid position includes regions that are not desired to be colored.

At S22, if the overlap is present between the preset region mask and the current grid position, a region in the current grid position outside the overlap between the current grid position and the region mask is determined as a target grid position.

If the overlap is present between the region mask and the current grid position, it may be considered that the current grid position includes regions that are not desired to be colored. Then, at this time, an uncovered region in the current grid position may be determined as the target grid position to avoid coloring the irrelevant region.

At S23, the current texture position of the texture map of the virtual model is determined based on the target grid position.

After the target grid position is determined, the current texture position of the texture map of the virtual model may be determined based on the target grid position, thereby determining the region in the texture map that needs to be colored.

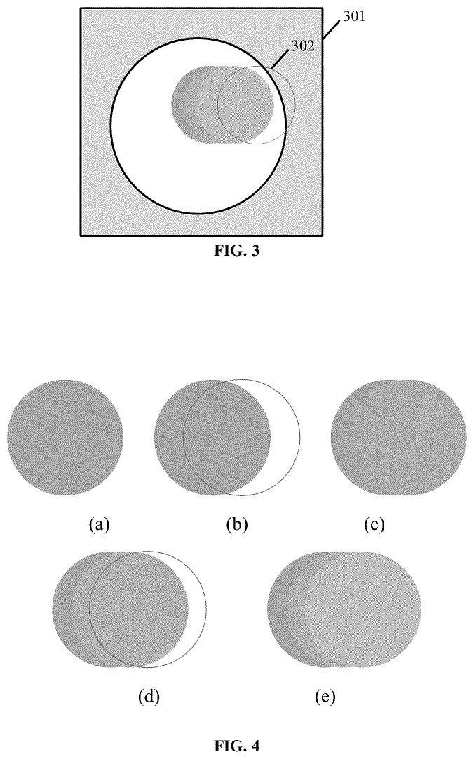

As an example of the present disclosure, FIG. 3 is a schematic diagram of a region mask of an embodiment of the present disclosure. If the current grid position 302 at which the touch control operation is located at the (n+1)-th frame is covered by the region mask 301, the region in the current grid position 302 outside the overlap between the current grid position 302 and the region mask 301 may be determined as the target grid position, and subsequent coloring is performed based on the target grid position, thereby avoiding that the coloring exceeds the allowed coloring region.

At step 203, a render texture corresponding to the touch control operation at an n-th timepoint is collected, and information, in the render texture, of a color of a historical touch control region of the touch control operation is obtained, where the render texture is a texture generated based on a color of a historical position of the touch control operation in the texture map.

Specifically, in order to achieve the color gradient effect, the color of the historical touch control region at which the touch control operation is located at the n-th timepoint may be mixed with the current color of the current texture position, so that the target color determined at each timepoint is changed based on the color of the historical touch control region, and thus the effect of the gradual change of color can be displayed.

Accordingly, the render texture corresponding to the n-th timepoint in the touch control operation may be collected in advance, so that in the case where the position changes of the texture map corresponding to the touch control operation may be discontinuous, the recording of the target color at the previous timepoint of the current timepoint can be achieved by collecting in advance the texture generated based on the color of the historical position at which the touch control operation is located in the texture map, in order to handle the color mixing. Specifically, the render texture records a variety of information such as the size, dimension, color, etc. of the historical touch control region. Therefore, the information of the color of the historical touch control region of the touch control operation may be obtained from the render texture.

In an embodiment of the present disclosure, the step of collecting the render texture corresponding to the touch control operation at the n-th timepoint includes step S31.

At S31, the render texture corresponding to the n-th timepoint is obtained by capturing, based on a virtual camera, the historical touch control region corresponding to the touch control operation at the n-th timepoint.

Specifically, the 3D processing software such as unity, houdini, etc., may provide the function of the virtual camera in the software, which may allow the user to obtain the render texture at a certain timepoint by capturing the virtual model.

As a result, the render texture corresponding to the n-th timepoint may be obtained by capturing, based on the virtual camera, the historical touch control region corresponding to the brush mask at the n-th timepoint, so that in the case where it is not possible to determine, based simply on the grid position on the virtual model or the texture position on the texture map, the position at which the touch control operation is located at the previous frame, the color information at the previous timepoint, i.e., the n-th timepoint, may be obtained based on the render texture for color mixing.

In an embodiment of the present disclosure, the step of collecting the render texture corresponding to the touch control operation at the n-th timepoint includes steps S41 to S42.

At S41, whether an overlap is present between a preset region mask and the historical touch control region corresponding to the touch control operation at the n-th timepoint is determined.

Specifically, the virtual model may not need to be colored at all positions, but only at part of the positions. Thus, in order to avoid the possibility of subsequent abnormal color mixing effects due to the collection and acquisition of positions unrelated to the virtual model coloring during the process of generating the render texture, whether the overlap is present between the preset region mask and the historical touch control region corresponding to the touch control operation at the n-th timepoint may be determined when the render texture is collected, thereby determining whether it is possible to collect color information of irrelevant positions.

At S42, if the overlap is present between the preset region mask and the historical touch control region corresponding to the touch control operation at the n-th timepoint, the render texture is obtained by collecting a region in the historical touch control region outside the overlap between the historical touch control region and the region mask.

If the overlap is present between the preset region mask and the historical touch control region corresponding to the touch control operation at the n-th timepoint, then at this time, in order to avoid collecting color information of irrelevant positions, the render texture may be obtained by collecting the region in the historical touch control region outside the overlap between the historical touch control region and the region mask, so that the colors can be mixed properly.

At step 204, a first mixing proportion corresponding to the historical touch control region, and a second mixing proportion corresponding to the current texture position are determined.

After the color of the historical touch control region is obtained through the render texture, from the texture map, the current texture position may be further determined, and the current color of the current texture position may be extracted. Subsequently, the target color of the current texture position may be determined by mixing the color of the historical touch control region with the current color of the current texture position.

In the process of mixing the color of the historical touch control region with the current color corresponding to the current texture position, proportions occupied by different colors in the target color may be determined respectively, thereby determining the coloring effect of the current texture position. As a result, the first mixing proportion corresponding to the historical touch control region and the second mixing proportion corresponding to the current texture position may be determined respectively. In some embodiments, the sum of the first mixing proportion and the second mixing proportion may be 100%.

In a specific implementation, the values of the first mixing proportion and the second mixing proportion may be determined according to actual needs. For example, in the case where the value of n+1 is small, in order to obtain a color that is closer to the preset initial color, the first mixing proportion may be set larger and the second mixing proportion may be set smaller. In the case where the value of n+1 is larger, in order to obtain a color that is closer to the original color of the virtual model, the first mixing proportion may be set smaller and the second mixing proportion may be set larger. For another example, in the case where the preset initial color is not obvious compared to the original color of the virtual model, in order to highlight the coloring effect, the first mixing proportion may be set larger and the second mixing proportion may be set smaller. In the case where the preset initial color is obvious compared to the original color of the virtual model, in order to avoid the added color being too strongly contrasted with the virtual model, the first mixing proportion may be set smaller and the second mixing proportion may be set larger.

At step 205, the target color of the current texture position is obtained by mixing, based on the first mixing proportion and the second mixing proportion, the color of the historical touch control region with the current color corresponding to the current texture position.

After the first mixing proportion and the second mixing proportion are determined, the target color of the current texture position may be obtained by mixing, based on the first mixing proportion and the second mixing proportion, the color of the historical touch control region with the current color corresponding to the current texture position, thereby determining the color effect to be displayed at the current texture position.

In a specific implementation, the target color may be calculated by using the following formula:

target color=color of the historical brush region×first mixing proportion+color of the current brush region×second mixing proportion.

At step 206, the color of the current texture position of the texture map is updated as the target color.

After the target color to be added to the current texture position is determined, the target color is used to update the color of the current texture position in the texture map, thereby completing the coloring of the texture corresponding to the current grid position in the virtual model.

The target color of the current texture position is determined based on the texture color corresponding to the historical touch control region at which the touch control operation is located at the previous timepoint, i.e., the n-th timepoint, and the texture color corresponding to the current touch control region, i.e., the (n+1)-th timepoint. As a result, the target color may be based on the color of the historical touch control region, and changed with reference to the current color of the current texture position. This allows for color gradient based on the color of the historical touch control region and better fusion with the current color of the virtual model, achieving a natural color gradient effect.

At step 207, the virtual model at the (n+1)-th timepoint is rendered based on the texture map as updated.

After the color of the current texture position of the texture map is updated, the virtual model at the (n+1)-th timepoint may be rendered by using the texture map as updated, so as to achieve the real-time display of the coloring effect of the virtual model during the process of coloring the virtual model through the touch control operation, and achieve the function of providing the user with real-time coloring and applying of the virtual model in the three-dimensional space.

As a specific example of the present disclosure, FIG. 4 is a schematic diagram of a virtual model coloring provided in an embodiment of the present disclosure.

As shown in (a) of FIG. 4, for the first timepoint, in response to the touch control operation on the virtual model, the current grid position of the touch control operation in the model grid of the virtual model at the first timepoint may be obtained, in order to determine the position of the virtual model that needs to be colored; thereafter, the current texture position of the texture map of the virtual model is determined based on the current grid position, and the color of the current texture position of the texture map is updated through the preset initial color, thereby achieving the initial coloring of the virtual model. After the virtual model at the first timepoint is rendered based on the texture map as updated, the render texture corresponding to the first timepoint may be obtained by capturing, based on the virtual camera, the historical touch control region corresponding to the touch control operation at the first timepoint.

As shown in (b) of FIG. 4, for the second timepoint, in response to the touch control operation on the virtual model, the current grid position of the touch control operation in the model grid of the virtual model at the second timepoint may be obtained. After the current texture position of the texture map of the virtual model is determined based on the current grid position, the information, in the render texture, of the color of the historical touch control region of the touch control operation may be obtained by collecting the render texture corresponding to the touch control operation at the first timepoint. After the target color of the current texture position is obtained by mixing the color of the historical touch control region with the current color of the current texture position, the color of the current texture position of the texture map is updated as the target color, and the virtual model at the second timepoint is rendered based on the texture map as updated, thereby enabling the real-time display of the coloring effect in the model. The coloring effect is shown in (c) of FIG. 4. Subsequently, the render texture corresponding to the second timepoint may be obtained by capturing, based on the virtual camera, the historical touch control region corresponding to the touch control operation at the second timepoint.

As shown in (d) of FIG. 4, for the third timepoint, in response to the touch control operation on the virtual model, the current grid position of the touch control operation in the model grid of the virtual model at the third timepoint may be obtained. After the current texture position of the texture map of the virtual model is determined based on the current grid position, the information, in the render texture, of the color of the historical touch control region of the touch control operation may be obtained by collecting the render texture corresponding to the touch control operation at the second timepoint. After the target color of the current texture position is obtained by mixing the color of the historical touch control region with the current color of the current texture position, the color of the current texture position of the texture map is updated as the target color, and the virtual model at the third timepoint is rendered based on the texture map as updated, thereby enabling the real-time display of the coloring effect in the model. The coloring effect is shown in (e) of FIG. 4. The coloring effect with the color gradient on the virtual model can thus be achieved.

Through the data processing method in the present disclosure, the current grid position of the touch control operation in the model grid of the virtual model at the current (n+1)-th timepoint is obtained in response to the touch control operation on the virtual model, where n≥1; the current texture position of the texture map of the virtual model is determined based on the current grid position; the render texture corresponding to the touch control operation at the n-th timepoint is collected, and the information, in the render texture, of the color of the historical touch control region of the touch control operation is obtained, where the render texture is the texture generated based on the color of the historical position of the touch control operation in the texture map; the first mixing proportion corresponding to the historical touch control region, and the second mixing proportion corresponding to the current texture position are determined; the target color of the current texture position is obtained by mixing, based on the first mixing proportion and the second mixing proportion, the color of the historical touch control region with the current color corresponding to the current texture position; the color of the current texture position of the texture map is updated as the target color; and the virtual model at the (n+1)-th timepoint is rendered based on the texture map as updated, so as to achieve the effect of coloring and applying the virtual model with the gradient color in the three-dimensional space.

It should be noted that for the method embodiments, they are all expressed as a series of combinations of actions for the sake of simple description, but those skilled in the art should be aware that the embodiments of the present disclosure are not limited by the described sequence of actions, as certain steps may be carried out in other sequences or at the same time according to the embodiments of the present disclosure. Secondly, those skilled in the art should also be aware that the embodiments described in the specification are all preferred embodiments, and the actions involved are not necessarily necessary for the embodiments of the present disclosure.

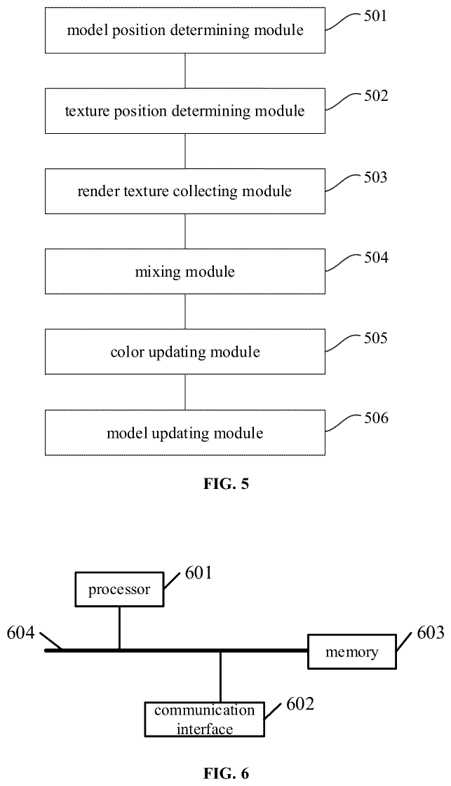

Referring to FIG. 5, a block diagram of a structure of a data processing apparatus provided in an embodiment of the present disclosure is shown, which specifically may include the following modules:
a model position determining module 501, configured to obtain, in response to a touch control operation on a virtual model, a current grid position of the touch control operation in a model grid of the virtual model at a current (n+1)-th timepoint, where n≥1;
a texture position determining module 502, configured to determine, based on the current grid position, a current texture position of a texture map of the virtual model;
a render texture collecting module 503, configured to collect a render texture corresponding to the touch control operation at an n-th timepoint, and obtain information, in the render texture, of a color of a historical touch control region of the touch control operation, where the render texture is a texture generated based on a color of a historical position of the touch control operation in the texture map;
a mixing module 504, configured to obtain a target color of the current texture position by mixing the color of the historical touch control region with a current color of the current texture position;
a color updating module 505, configured to update the color of the current texture position of the texture map as the target color; and
a model updating module 506, configured to render, based on the texture map as updated, the virtual model at the (n+1)-th timepoint.

Optionally, the texture position determining module includes:
a first overlap determining sub-module, configured to determine whether an overlap is present between a preset region mask and the current grid position;
a target grid position determining sub-module, configured to, if the overlap is present between the preset region mask and the current grid position, determine a region in the current grid position outside the overlap between the current grid position and the region mask as a target grid position; and
a texture position determining sub-module, configured to determine, based on the target grid position, the current texture position of the texture map of the virtual model.

Optionally, the render texture collecting module includes:
a first render texture collecting sub-module, configured to obtain the render texture corresponding to the n-th timepoint by capturing, based on a virtual camera, the historical touch control region corresponding to the touch control operation at the n-th timepoint.

Optionally, the render texture collecting module includes:
a second overlap determining sub-module, configured to determine whether an overlap is present between a preset region mask and the historical touch control region corresponding to the touch control operation at the n-th timepoint; and
a second render texture collecting sub-module, configured to, if the overlap is present between the preset region mask and the historical touch control region corresponding to the touch control operation at the n-th timepoint, obtain the render texture by collecting a region in the historical touch control region outside the overlap between the historical touch control region and the region mask.

Optionally, the apparatus further includes:
a first timepoint model position determining module, configured to, for a first timepoint, obtain, in response to the touch control operation on the virtual model, a current grid position of the touch control operation in the model grid of the virtual model at the first timepoint;
a first timepoint texture position determining module, configured to determine, based on the current grid position, a current texture position of the texture map of the virtual model;
an initial color updating module, configured to update a color of the current texture position of the texture map as a preset initial color;
a first timepoint rendering module, configured to render, based on the texture map as updated, the virtual model at the first timepoint.

Optionally, the mixing module includes:
a proportion determining sub-module, configured to determine a first mixing proportion corresponding to the historical touch control region, and a second mixing proportion corresponding to the current texture position; and
a mixing sub-module, configured to obtain the target color of the current texture position by mixing, based on the first mixing proportion and the second mixing proportion, the color of the historical touch control region with the current color corresponding to the current texture position.

For the apparatus embodiments, the description is relatively simple because they are substantially similar to the method embodiments, and it is sufficient to refer to part of the description of the method embodiments for relevant information.

In addition, the embodiments of the present disclosure also provide an electronic device, as shown in FIG. 6, including a processor 601, a communication interface 602, a memory 603, and a communication bus 604, where the processor 601, the communication interface 602, and the memory 603 communicate with each other via the communication bus 604.

The memory 603 is configured to store a computer program.

The processor 601, when executing the program stored in the memory 603, is configured to implement the following steps:
obtaining, in response to a touch control operation on a virtual model, a current grid position of the touch control operation in a model grid of the virtual model at a current (n+1)-th timepoint, where n≥1;
determining, based on the current grid position, a current texture position of a texture map of the virtual model;
collecting a render texture corresponding to the touch control operation at an n-th timepoint, and obtaining information, in the render texture, of a color of a historical touch control region of the touch control operation, where the render texture is a texture generated based on a color of a historical position of the touch control operation in the texture map;
obtaining a target color of the current texture position by mixing the color of the historical touch control region with a current color of the current texture position;
updating the color of the current texture position of the texture map as the target color; and
rendering, based on the texture map as updated, the virtual model at the (n+1)-th timepoint.

Optionally, the step of determining, based on the current grid position, the current texture position of the texture map of the virtual model includes:
determining whether an overlap is present between a preset region mask and the current grid position;
if the overlap is present between the preset region mask and the current grid position, determining a region in the current grid position outside the overlap between the current grid position and the region mask as a target grid position; and
determining, based on the target grid position, the current texture position of the texture map of the virtual model.

Optionally, the step of collecting the render texture corresponding to the touch control operation at the n-th timepoint includes:
obtaining the render texture corresponding to the n-th timepoint by capturing, based on a virtual camera, the historical touch control region corresponding to the touch control operation at the n-th timepoint.

Optionally, the step of collecting the render texture corresponding to the touch control operation at the n-th timepoint includes:
determining whether an overlap is present between a preset region mask and the historical touch control region corresponding to the touch control operation at the n-th timepoint; and
if the overlap is present between the preset region mask and the historical touch control region corresponding to the touch control operation at the n-th timepoint, obtaining the render texture by collecting a region in the historical touch control region outside the overlap between the historical touch control region and the region mask.

Optionally, the method further includes:
for a first timepoint, obtaining, in response to the touch control operation on the virtual model, a current grid position of the touch control operation in the model grid of the virtual model at the first timepoint;
determining, based on the current grid position, a current texture position of the texture map of the virtual model;
updating a color of the current texture position of the texture map as a preset initial color; and
rendering, based on the texture map as updated, the virtual model at the first timepoint.

Optionally, the step of obtaining the target color of the current texture position by mixing the color of the historical touch control region with the current color of the current texture position includes:
determining a first mixing proportion corresponding to the historical touch control region, and a second mixing proportion corresponding to the current texture position; and
obtaining the target color of the current texture position by mixing, based on the first mixing proportion and the second mixing proportion, the color of the historical touch control region with the current color corresponding to the current texture position.

Through performing the steps of the data processing method in the present disclosure, the current grid position of the touch control operation in the model grid of the virtual model at the current (n+1)-th timepoint is obtained in response to the touch control operation on the virtual model, where n≥1; the current texture position of the texture map of the virtual model is determined based on the current grid position; the render texture corresponding to the touch control operation at the n-th timepoint is collected, and the information, in the render texture, of the color of the historical touch control region of the touch control operation is obtained, where the render texture is the texture generated based on the color of the historical position of the touch control operation in the texture map; the first mixing proportion corresponding to the historical touch control region, and the second mixing proportion corresponding to the current texture position are determined; the target color of the current texture position is obtained by mixing, based on the first mixing proportion and the second mixing proportion, the color of the historical touch control region with the current color corresponding to the current texture position; the color of the current texture position of the texture map is updated as the target color; and the virtual model at the (n+1)-th timepoint is rendered based on the texture map as updated, so as to achieve the effect of coloring and applying the virtual model with the gradient color in the three-dimensional space.

The communication bus referred to in the above terminals may be a peripheral component interconnect (PCI) bus or extended industry standard architecture (EISA) bus, etc. The communication bus may be divided into the address bus, data bus, control bus, etc. For ease of representation, the figure is shown with only a thick line, but this does not indicate that there is only one bus or one type of bus.

The communication interface is used for communication between the terminal described above and other devices.

The memory may include a random access memory (RAM), or may include a non-volatile memory, such as at least one disk memory. Optionally, the memory may also be at least one storage device located away from the aforementioned processor.

The aforementioned processor may be a general-purpose processor, including a central processing unit (CPU), a network processor (NP), etc.; the processor may also be a digital signal processing (DSP), an application specific integrated circuit (ASIC), a field-programmable gate array (FPGA), or other programmable logic devices, discrete gates, transistor logic devices, or discrete hardware components.

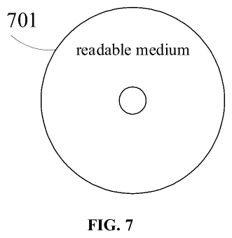

As shown in FIG. 7, in yet another embodiment provided in the present disclosure, there is also provided a computer-readable storage medium 701 storing an instruction that, when run on a computer, causes the computer to perform the data processing method described in the above embodiment, and specifically the following steps may be implemented:
obtaining, in response to a touch control operation on a virtual model, a current grid position of the touch control operation in a model grid of the virtual model at a current (n+1)-th timepoint, where n≥1;
determining, based on the current grid position, a current texture position of a texture map of the virtual model;
collecting a render texture corresponding to the touch control operation at an n-th timepoint, and obtaining information, in the render texture, of a color of a historical touch control region of the touch control operation, where the render texture is a texture generated based on a color of a historical position of the touch control operation in the texture map;
obtaining a target color of the current texture position by mixing the color of the historical touch control region with a current color of the current texture position;
updating the color of the current texture position of the texture map as the target color; and
rendering, based on the texture map as updated, the virtual model at the (n+1)-th timepoint.

Optionally, the step of determining, based on the current grid position, the current texture position of the texture map of the virtual model includes:
determining whether an overlap is present between a preset region mask and the current grid position;
if the overlap is present between the preset region mask and the current grid position, determining a region in the current grid position outside the overlap between the current grid position and the region mask as a target grid position; and
determining, based on the target grid position, the current texture position of the texture map of the virtual model.

Optionally, the step of collecting the render texture corresponding to the touch control operation at the n-th timepoint includes:
obtaining the render texture corresponding to the n-th timepoint by capturing, based on a virtual camera, the historical touch control region corresponding to the touch control operation at the n-th timepoint.

Optionally, the step of collecting the render texture corresponding to the touch control operation at the n-th timepoint includes:
determining whether an overlap is present between a preset region mask and the historical touch control region corresponding to the touch control operation at the n-th timepoint; and
if the overlap is present between the preset region mask and the historical touch control region corresponding to the touch control operation at the n-th timepoint, obtaining the render texture by collecting a region in the historical touch control region outside the overlap between the historical touch control region and the region mask.

Optionally, the method further includes:
for a first timepoint, obtaining, in response to the touch control operation on the virtual model, a current grid position of the touch control operation in the model grid of the virtual model at the first timepoint;
determining, based on the current grid position, a current texture position of the texture map of the virtual model;
updating a color of the current texture position of the texture map as a preset initial color; and
rendering, based on the texture map as updated, the virtual model at the first timepoint.

Optionally, the step of obtaining the target color of the current texture position by mixing the color of the historical touch control region with the current color of the current texture position includes:
determining a first mixing proportion corresponding to the historical touch control region, and a second mixing proportion corresponding to the current texture position; and
obtaining the target color of the current texture position by mixing, based on the first mixing proportion and the second mixing proportion, the color of the historical touch control region with the current color corresponding to the current texture position.

Through performing the steps of the data processing method in the present disclosure, the current grid position of the touch control operation in the model grid of the virtual model at the current (n+1)-th timepoint is obtained in response to the touch control operation on the virtual model, where n≥1; the current texture position of the texture map of the virtual model is determined based on the current grid position; the render texture corresponding to the touch control operation at the n-th timepoint is collected, and the information, in the render texture, of the color of the historical touch control region of the touch control operation is obtained, where the render texture is the texture generated based on the color of the historical position of the touch control operation in the texture map; the first mixing proportion corresponding to the historical touch control region, and the second mixing proportion corresponding to the current texture position are determined; the target color of the current texture position is obtained by mixing, based on the first mixing proportion and the second mixing proportion, the color of the historical touch control region with the current color corresponding to the current texture position; the color of the current texture position of the texture map is updated as the target color; and the virtual model at the (n+1)-th timepoint is rendered based on the texture map as updated, so as to achieve the effect of coloring and applying the virtual model with the gradient color in the three-dimensional space.

In yet another embodiment provided in the present disclosure, there is also provided a computer program product including an instruction that, when run on a computer, causes the computer to perform the data processing method described in the above embodiment, thereby achieving the effect of coloring and applying the virtual model with the gradient color in the three-dimensional space. Specifically the following steps may be implemented:
obtaining, in response to a touch control operation on a virtual model, a current grid position of the touch control operation in a model grid of the virtual model at a current (n+1)-th timepoint, where n≥1;
determining, based on the current grid position, a current texture position of a texture map of the virtual model;
collecting a render texture corresponding to the touch control operation at an n-th timepoint, and obtaining information, in the render texture, of a color of a historical touch control region of the touch control operation, where the render texture is a texture generated based on a color of a historical position of the touch control operation in the texture map;
obtaining a target color of the current texture position by mixing the color of the historical touch control region with a current color of the current texture position;
updating the color of the current texture position of the texture map as the target color; and
rendering, based on the texture map as updated, the virtual model at the (n+1)-th timepoint.

Optionally, the step of determining, based on the current grid position, the current texture position of the texture map of the virtual model includes:
determining whether an overlap is present between a preset region mask and the current grid position;
if the overlap is present between the preset region mask and the current grid position, determining a region in the current grid position outside the overlap between the current grid position and the region mask as a target grid position; and
determining, based on the target grid position, the current texture position of the texture map of the virtual model.

Optionally, the step of collecting the render texture corresponding to the touch control operation at the n-th timepoint includes:
obtaining the render texture corresponding to the n-th timepoint by capturing, based on a virtual camera, the historical touch control region corresponding to the touch control operation at the n-th timepoint.

Optionally, the step of collecting the render texture corresponding to the touch control operation at the n-th timepoint includes:
determining whether an overlap is present between a preset region mask and the historical touch control region corresponding to the touch control operation at the n-th timepoint; and
if the overlap is present between the preset region mask and the historical touch control region corresponding to the touch control operation at the n-th timepoint, obtaining the render texture by collecting a region in the historical touch control region outside the overlap between the historical touch control region and the region mask.

Optionally, the method further includes:
for a first timepoint, obtaining, in response to the touch control operation on the virtual model, a current grid position of the touch control operation in the model grid of the virtual model at the first timepoint;
determining, based on the current grid position, a current texture position of the texture map of the virtual model;
updating a color of the current texture position of the texture map as a preset initial color; and
rendering, based on the texture map as updated, the virtual model at the first timepoint.

Optionally, the step of obtaining the target color of the current texture position by mixing the color of the historical touch control region with the current color of the current texture position includes:
determining a first mixing proportion corresponding to the historical touch control region, and a second mixing proportion corresponding to the current texture position; and
obtaining the target color of the current texture position by mixing, based on the first mixing proportion and the second mixing proportion, the color of the historical touch control region with the current color corresponding to the current texture position.

Through performing the steps of the data processing method in the present disclosure, the current grid position of the touch control operation in the model grid of the virtual model at the current (n+1)-th timepoint is obtained in response to the touch control operation on the virtual model, where n≥1; the current texture position of the texture map of the virtual model is determined based on the current grid position; the render texture corresponding to the touch control operation at the n-th timepoint is collected, and the information, in the render texture, of the color of the historical touch control region of the touch control operation is obtained, where the render texture is the texture generated based on the color of the historical position of the touch control operation in the texture map; the first mixing proportion corresponding to the historical touch control region, and the second mixing proportion corresponding to the current texture position are determined; the target color of the current texture position is obtained by mixing, based on the first mixing proportion and the second mixing proportion, the color of the historical touch control region with the current color corresponding to the current texture position; the color of the current texture position of the texture map is updated as the target color; and the virtual model at the (n+1)-th timepoint is rendered based on the texture map as updated, so as to achieve the effect of coloring and applying the virtual model with the gradient color in the three-dimensional space.

The above embodiments may be implemented in whole or in part by software, hardware, firmware, or any combination thereof. When implemented by using the software, the above embodiments may be implemented in whole or in part in the form of a computer program product. The computer program product includes one or more computer instructions. When the computer program instructions are loaded and executed on a computer, the process or function in accordance with the embodiments of the present disclosure may be produced in whole or in part. The computer may be a general-purpose computer, a special-purpose computer, a computer network, or other programmable devices. The computer instruction may be stored in a computer-readable storage medium or transmitted from one computer-readable storage medium to another computer-readable storage medium, e.g., the computer instruction may be transmitted by wired (e.g., coaxial cable, fiber optic, digital subscriber line (DSL)) or wireless (e.g., infrared, wireless, microwave, etc.) means from one website site, computer, server, or data center to another website site, computer, server or data center. The computer-readable storage medium may be any usable medium to which a computer has access or a data storage device such as a server, data center, etc. including one or more usable media integrated. The usable medium may be a magnetic medium (e.g., floppy disk, hard drive, tape), an optical medium (e.g., DVD), or a semiconductor medium (e.g., a solid state disk (SSD)), and the like.

It is noted that in this article, relational terms such as first and second are used only to distinguish one entity or operation from another entity or operation, and do not necessarily require or imply that any such actual relationship or order exists between these entities or operations. Further, the terms “include”, “comprise”, or any other variant thereof, are intended to cover non-exclusive inclusion, such that a process, method, item, or apparatus including a set of elements includes not only those elements, but also other elements not expressly listed, or also includes elements that are inherent to such process, method, item or apparatus. Without further limitation, the element limited by the statement “including a . . . ” does not exclude the existence of other identical elements in the process, method, item, or apparatus that includes the element.

The embodiments in this specification are described in a related manner, and the same and similar parts of the embodiments are referred to each other, with each embodiment focusing on differences from the other embodiments. In particular, for the system embodiments, since they are basically similar to the method embodiments, they are described in a simple manner, and it is sufficient to refer to part of the description of the method embodiments for relevant information.

The foregoing is only preferred embodiments of the present disclosure, and is not intended to limit the scope of protection of the present disclosure. Any modifications, equivalent substitutions, improvements, etc. made within the spirit and principles of the present disclosure are included in the scope of protection of the present disclosure.

1. A data processing method, comprising:
obtaining, by an electronic device in response to a touch control operation on a virtual model, a first grid position of the touch control operation in a model grid of the virtual model at a (n+1)-th timepoint, wherein n≥1;
determining, by the electronic device based on the first grid position, a first texture position of a texture map of the virtual model;
obtaining, by the electronic device, in a render texture corresponding to the touch control operation at an n-th timepoint, information of a color of a historical touch control region of the touch control operation, wherein the render texture is a texture generated based on a color of a historical position of the touch control operation in the texture map;
obtaining, by the electronic device, a target color of the first texture position by mixing the color of the historical touch control region with a color of the first texture position;
updating, by the electronic device, the color of the first texture position of the texture map as the target color; and
rendering, by the electronic device based on the texture map as updated, the virtual model at the (n+1)-th timepoint.

2. The method according to claim 1, wherein the determining the first texture position comprises:
determining whether an overlap is present between a preset region mask and the first grid position;
determining, in response to determining that the overlap is present, a region in the first grid position outside the overlap between the first grid position and the region mask as a target grid position; and
determining, based on the target grid position, the first texture position of the texture map of the virtual model.

3. The method according to claim 1, further comprising:
obtaining the render texture corresponding to the n-th timepoint by capturing, based on a virtual camera, the historical touch control region corresponding to the touch control operation at the n-th timepoint.

4. The method according to claim 1, further comprising:
determining whether an overlap is present between a preset region mask and the historical touch control region; and
obtaining, in response to determining that the overlap is present, the render texture corresponding to the n-th timepoint by capturing, based on a virtual camera, a region in the historical touch control region outside the overlap.

5. The method according to claim 1, further comprising:
obtaining an initial grid position of the touch control operation in the model grid of the virtual model at a first timepoint;
determining, based on the initial grid position, an initial texture position of the texture map of the virtual model;
updating a color of the initial texture position of the texture map as a preset initial color; and
rendering, based on the texture map as updated through the preset initial color, the virtual model at the first timepoint.

6. The method according to claim 1, wherein the obtaining the target color of the first texture position comprises:
determining a first mixing proportion corresponding to the historical touch control region, and a second mixing proportion corresponding to the first texture position; and
obtaining the target color of the first texture position by mixing, based on the first mixing proportion and the second mixing proportion, the color of the historical touch control region with the color of the first texture position.

7-8. (canceled)

9. An electronic device, comprising a processor, a communication interface, a memory, and a communication bus, wherein the processor, the communication interface, and the memory communicate with each other through the communication bus;
the memory is configured to store a computer program; and
the processor, through executing the program stored in the memory, is configured to:
obtain, in response to a touch control operation on a virtual model, a first grid position of the touch control operation in a model grid of the virtual model at a (n+1)-th timepoint, wherein n≥1;
determine, based on the first grid position, a first texture position of a texture map of the virtual model;
obtain information, in a render texture corresponding to the touch control operation at an n-th timepoint, of a color of a historical touch control region of the touch control operation, wherein the render texture is a texture generated based on a color of a historical position of the touch control operation in the texture map;
obtain, a target color of the first texture position by mixing the color of the historical touch control region with a color of the first texture position;
update the color of the first texture position of the texture map as the target color; and
render, based on the texture map as updated, the virtual model at the (n+1)-th timepoint.

10. A non-transitory computer-readable medium, storing an instruction that, when executed by one or more processors, causes the processor to perform a data processing method, wherein the method comprises:
obtaining, in response to a touch control operation on a virtual model, a first grid position of the touch control operation in a model grid of the virtual model at a (n+1)-th timepoint, wherein n≥1;
determining, based on the first grid position, a first texture position of a texture map of the virtual model;
obtaining information, in a render texture corresponding to the touch control operation at an n-th timepoint, of a color of a historical touch control region of the touch control operation, wherein the render texture is a texture generated based on a color of a historical position of the touch control operation in the texture map;
obtaining, a target color of the first texture position by mixing the color of the historical touch control region with a color of the first texture position;
updating the color of the first texture position of the texture map as the target color; and
rendering, based on the texture map as updated, the virtual model at the (n+1)-th timepoint.

11. The method according to claim 3, wherein the obtaining the render texture comprises:
determining whether an overlap is present between a preset region mask and the historical touch control region; and
obtaining, in response to determining that the overlap is present, the render texture by capturing, based on the virtual camera, a region in the historical touch control region outside the overlap.

12. The method according to claim 1, wherein the touch control operation is configured for controlling a brush mask, and the obtaining the first grid position comprises:
determining a position in the model grid of the virtual model covered by the brush mask at the (n+1)-th timepoint as the first grid position.

13. The method according to claim 1, wherein the determining the first texture position comprises:
determining the first texture position based on a preset correspondence relationship between a grid position of the model grid in a three-dimensional space and a texture position of the texture map of the virtual model.

14. The method according to claim 1, wherein the touch control operation is a continuous and uninterrupted movement.

15. The method according to claim 6, wherein as a value of n+1 decreases, the first mixing proportion increases and the second mixing proportion decreases; and
as the value of n+1 increases, the first mixing proportion decreases and the second mixing proportion increases.

16. The electronic device according to claim 9, wherein the processor is specifically configured to:
determine whether an overlap is present between a preset region mask and the first grid position;
determine, in response to determining that the overlap is present, a region in the first grid position outside the overlap between the first grid position and the region mask as a target grid position; and
determine, based on the target grid position, the first texture position of the texture map of the virtual mode.

17. The electronic device according to claim 9, wherein the processor is further configured to:
obtain the render texture corresponding to the n-th timepoint by capturing, based on a virtual camera, the historical touch control region corresponding to the touch control operation at the n-th timepoint.

18. The electronic device according to claim 9, wherein the processor is further configured to:
determine whether an overlap is present between a preset region mask and the historical touch control region; and
obtain, in response to determining that the overlap is present, the render texture by capturing, based on the virtual camera, a region in the historical touch control region outside the overlap.

19. The electronic device according to claim 9, wherein the processor is further configured to:
obtain an initial grid position of the touch control operation in the model grid of the virtual model at a first timepoint;
determine, based on the initial grid position, an initial texture position of the texture map of the virtual model;
update a color of the initial texture position of the texture map as a preset initial color; and
render, based on the texture map as updated through the preset initial color, the virtual model at the first timepoint.

20. The electronic device according to claim 9, wherein the processor is specifically configured to:
determine a first mixing proportion corresponding to the historical touch control region, and a second mixing proportion corresponding to the first texture position; and
obtain the target color of the first texture position by mixing, based on the first mixing proportion and the second mixing proportion, the color of the historical touch control region with the color of the first texture position.

21. The non-transitory computer-readable medium according to claim 10, wherein the determining the first texture position comprises:
determining whether an overlap is present between a preset region mask and the first grid position;
determining, in response to determining that the overlap is present, a region in the first grid position outside the overlap between the first grid position and the region mask as a target grid position; and
determining, based on the target grid position, the first texture position of the texture map of the virtual model.

22. The non-transitory computer-readable medium according to claim 10, wherein the method further comprises:
obtaining the render texture corresponding to the n-th timepoint by capturing, based on a virtual camera, the historical touch control region corresponding to the touch control operation at the n-th timepoint.
